(19) United States
(12) Patent Application Publication
(10) Pub. No.: US 2014/0193571 A1
(43) Pub. Date: Jul. 10, 2014

(54) LOW GLOSS METALLIC COLOR COATING

(71) Applicants: Ayumu Yokoyama, Wallingford, PA (US); Rajesh Gopalan Saliya, Wilmington, DE (US); Anthony Moy, Garnet Valley, PA (US)

(72) Inventors: Ayumu Yokoyama, Wallingford, PA (US); Rajesh Gopalan Saliya, Wilmington, DE (US); Anthony Moy, Garnet Valley, PA (US)

(21) Appl. No.: 14/234,055

(22) PCT Filed: Jul. 23, 2012
(86) PCT No.: PCT/US2012/047845

§ 371 Date: Mar. 12, 2014

Related U.S. Application Data
(60) Provisional application No. 61/510,239, filed on Jul. 21, 2011.

(51) Int. Cl. G05D 11/00; B05D 5/02

(52) U.S. Cl. CPC G05D 11/00; B05D 5/02
USPC 427/8; 106/1.05; 700/265

(57) ABSTRACT

The present disclosure is directed to a process for producing a low gloss metallic color coating composition having a target gloss value. The low gloss metallic color coating composition can be produced from a high gloss metallic color coating composition with the addition of a matting agent. The disclosure is also directed to a coating system using the process. This disclosure is also directed to a method for matching color, flake appearance, and gloss of a coating. The processes, methods and systems of this disclosure are particularly useful for producing a low gloss metallic color coating composition having a target gloss value when the high gloss metallic color coating composition comprises both metallic effect pigments and color pigments.

### CROSS-REFERENCE TO RELATED APPLICATIONS

This application is a U.S. National-Stage entry under 35 U.S.C. §371 based on International Application No. PCT/US2012/047845, filed Jul. 23, 2012 which was published under PCT Article 21(2) and which claims priority to U.S. Application No. 61/510,239, filed Jul. 21, 2011, which are all hereby incorporated in their entirety by reference.

### FIELD OF INVENTION

The present disclosure is directed to process for producing a low gloss metallic color coating composition having a target gloss value. The disclosure is also directed to a coating system using the process.

### BACKGROUND OF INVENTION

Consumers' and industrial desires on coating appearance are diversified. Sometimes, a preference is given to coatings having low gloss or low luster. These desires present challenges to the coating industry for producing coatings that have varied appearances including low gloss or low luster with reduced shining, reflecting light, glitter, sparkle or sheen. Typically, such coatings with low gloss are produced by incorporating a matting agent that imparting matting effect. The matting agent can be inorganic particles, such as silicon compound particles. Currently, to produce a coating having a specific range of low gloss value, a plurality of mixing ratios of a matting agent and a coating composition need to be mixed and repeated spray-out are need.

Therefore, needs arise for a better method to produce a low gloss coating having a specific low gloss value. In addition, other objects, desirable features and characteristics will become apparent from the subsequent summary and detailed description, and the appended claims, taken in conjunction with the accompanying drawings and this background.

### SUMMARY

This disclosure is directed to a process for producing a low gloss metallic color coating composition having a target gloss value, said process comprising the steps of:
a) producing a first ratio of a matting agent and a first high gloss coating component based on a first gloss correlation function and said target gloss value, wherein said first gloss correlation function is associated with a plurality of measured gloss values and mixing ratios of said first high gloss coating component and said matting agent; and
b) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent.

This disclosure is also directed to a process for producing a low gloss metallic color coating composition having a target gloss value from a high gloss metallic color coating composition, said high gloss metallic color coating composition comprising a binder component, one or more metallic effect pigments and one or more color pigments, said process comprising the steps of:
(A) identifying a first high gloss coating component comprising a first binder component and said one or more metallic effect pigments, but free from said one or more color pigments;
(B) identifying a second high gloss coating component comprising a second binder component and said one or more color pigments, but free from said one or more metallic effect pigments;
(C) producing a first ratio of a matting agent and said first high gloss coating component based on a first gloss correlation function and said target gloss value, wherein said first gloss correlation function is associated with a plurality of measured gloss values and mixing ratios of said first high gloss coating component and said matting agent;
(D) producing a second ratio of the matting agent and the second high gloss coating component based on a second gloss correlation function and said target gloss value, wherein said second gloss correlation function is associated with a plurality of measured gloss values and mixing ratios of said second high gloss coating component and said matting agent;
(E) producing a target amount of the matting agent based on the first ratio, the second ratio, and a predetermined target amount of the low gloss metallic color coating composition; and
wherein, said binder component, said first and said second binder components are the same or compatible to each other.

This disclosure is further directed a coating system for producing a low gloss metallic color coating composition having a target gloss value.

This disclosure is also directed to a method for producing a matching coating layer to match flake appearance characteristics, color characteristics and a target gloss value of a target coating.

### BRIEF DESCRIPTION OF DRAWINGS

The present invention will hereinafter be described in conjunction with the following drawing figures, wherein like numerals denote like elements, and:

FIG. 1 shows an example of a gloss correlation function associated with gloss values and mixing ratios of a metallic coating component and a matting agent.

FIG. 2 shows an example of a gloss correlation function associated with gloss values and mixing ratios of a solid blue color coating component and a matting agent.

FIG. 3 shows an example of a gloss correlation function associated with gloss values and mixing ratios of a solid yellow color coating component and a matting agent.

FIG. 4 shows an example of a gloss correlation function associated with gloss values and mixing ratios of a binder component and a matting agent.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

“Gloss” means surface gloss of a coating surface and is related to the amount of incident light that is reflected at the specular reflectance angle of the mean of that surface. Gloss can be measured with a specular glossmeter, such as those available from Byk-Gardener, Geretsried, Germany.

The term “two-pack coating composition” or “2K coating composition” refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, adhesion, gloss, and DOI.

The term “one-pack coating composition” or “1K coating composition” refers to a coating composition having one package that can be stored for a certain shelf life. For example, a 1K coating composition can be a UV mono-cure coating composition that can be prepared to form a pot mix and stored in a sealed container. As long as the UV mono-cure coating composition is not exposed to UV radiation, the UV mono-cure coating composition can have indefinite pot life. Other examples of 1K coating composition can include 1K coating compositions having blocked crosslinking agent such as blocked isocyanates, moisture curing 1K coating compositions, oxygen curing 1K coating compositions, or heat curing 1K coating compositions as known in coating industry.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide or a workable combination thereof.

The term “matting agent” refers to a composition that can be used to matt a glossy surface or reduce the gloss of surface. A matting agent can be used to reduce or control gloss of coatings. The matting agent can comprise particles of organic or inorganic materials. The particles can have an average particle size in a range of from 2 to 20 micrometers (μm) in one example, in a range of from 2 to 10 micrometers (μm) in another example, and in a range of from 2 to 8 micrometers (μm) in yet another example. In yet another example, the matting agent can comprise silica particles having an average particle size in a range of from 2 to 20 micrometers (μm). In yet another example, the matting agent can consist of silica particles having an average particle size in a range of from 2 to 20 micrometers (μm). The particles can have different surface treatment. In one example, the particles can be organic surface treated silica particles. In another example, the particles can be untreated, such as untreated silica particles. In yet another example, the particles can be thermally treated, such as thermally treated silica particles. Silica particles having hydrophobic surface property can be preferred. Commercial available silica particles, such those available under the trademark ACEMATT® from marketed Degussa Evonik, can be suitable for this invention. Silica particles that have organic surface-treatment, such as ACEMATT® OK 412 can be preferred. Commercial matting agents, such as 9T20® available from E. I. DuPont de Nemours and Company, Wilmington, Del., USA, under respective registered trademark, can be suitable.

The term “computing device” used herein refers to a desktop computer, a laptop computer, a pocket PC, a tablet, a personal digital assistant (PDA), a handheld electronic processing device, a mobile phone, a smart phone that combines the functionality of a PDA and a mobile phone, or any other electronic devices that can process information automatically. A computing device may have wired or wireless connections to one or more databases or to one or more other computing devices. A computing device can be a client computer that communicates with a host computer in a multi-computer client-host system connected via a wired or wireless network including intranet and internet.

The term “free from metallic effect pigments” or “essentially free from metallic effect pigments” means that the presence of the metallic effect pigments is at the minimum and has no detectable metallic effect, typically in a range of less than 5% of the total weight of a coating composition.

The term “free from color pigments” or “essentially free from color pigments” means that the presence of the color pigments is at the minimum and has no detectable color effect, typically in a range of less than 5% of the total weight of a coating composition.

This disclosure is directed to a process for producing a low gloss metallic color coating composition having a target gloss value. The process can comprise the steps of:

a) producing a first ratio of a matting agent and a first high gloss coating component based on a first gloss correlation function and the target gloss value, wherein said first gloss correlation function is associated with a plurality of measured gloss values and mixing ratios of said first high gloss coating component and said matting agent; and

b) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent.

The process can further comprise the steps of:

c) determining fractional amounts of said first and said second high gloss coating components according to a predetermined target amount of the low gloss metallic color coating composition;

d) producing a target amount of the matting agent based on the first ratio, the second ratio, and said fractional amounts; and

e) producing said low gloss metallic color coating composition by mixing said target amount of the matting agent and said fractional amounts of said first and said second high gloss coating components.

The first high gloss coating component can comprise a metallic coating composition comprising a first binder component and one or more metallic effect pigments dispersed in said first binder component, said first high gloss coating component is essentially free from color pigments; and wherein said second high gloss coating component comprises at least one color coating composition comprising a second binder component and one or more color pigments dispersed in said second binder component, said second high gloss coating component is essentially free from metallic effect pigments; and wherein said first and said second binder components are the same or compatible to each other.

The first or the second gloss correlation function can be generated by a correlation process comprising the steps of:

i) mixing said matting agent and one of said high gloss coating components at at least two individual mixing ratios to produce individual matt coating compositions;

ii) applying said individual matt coating compositions over individual substrates to form individual matt coating layers;

iii) measuring individual gloss values of said individual matt coating layers; and

iv) generating said first or said second gloss correlation function by plotting or performing a regression according to said individual mixing ratios and said corresponding individual gloss values.

The process can further comprise the steps of:

f) producing a third ratio of the matting agent and a third high gloss coating component based on a third gloss correlation function and said target gloss value, wherein said third gloss correlation function is associated with a plurality of measured gloss values and mixing ratios of said third high gloss coating component and said matting agent;

g) determining fractional amounts of said first, said second and said third high gloss coating components according to a predetermined target amount of the low gloss metallic color coating composition; and

h) producing a target amount of the matting agent based on the first ratio, the second ratio, the third ration, and said fractional amounts.

The process can further comprise the steps of:

h1) producing said low gloss metallic color coating composition by mixing said target amount of the matting agent and said fractional amounts of said first, said second and said third high gloss coating components.

The first high gloss coating component can comprise a metallic coating composition comprising a first binder component and one or more metallic effect pigments, said metallic coating composition is essentially free from color pigments; wherein the second high gloss coating component can comprise a color coating composition comprising a second binder component and one or more color pigments, said color coating composition is essentially free from metallic effect pigments; and wherein the third high gloss coating component can comprise a third binder component and is essentially free from both metallic effect pigments and color pigments; and wherein the first, the second and the third binder components can be the same or compatible to each other.

The first, the second or the third gloss correlation function can be generated by the aforementioned process.

The individual substrates can be one substrate, multiple separate substrates, different portion of a substrate, or a combination thereof The individual matt coating composition can also be applied over one substrate, multiple separate substrates, different portion of a substrate one substrate, or a combination thereof.

This disclosure is also directed to a process for producing a low gloss metallic color coating composition having a target gloss value from a high gloss metallic color coating composition, the high gloss metallic color coating composition comprising a binder component, one or more metallic effect pigments and one or more color pigments. The process can comprise the steps of:

(A) identifying a first high gloss coating component comprising a first binder component and said one or more metallic effect pigments, but free from said one or more color pigments;

(B) identifying a second high gloss coating component comprising a second binder component and said one or more color pigments, but free from said one or more metallic effect pigments;

(C) producing a first ratio of a matting agent and said first high gloss coating component based on a first gloss correlation function and said target gloss value, wherein said first gloss correlation function is associated with a plurality of measured gloss values and mixing ratios of said first high gloss coating component and said matting agent;

(D) producing a second ratio of the matting agent and the second high gloss coating component based on a second gloss correlation function and said target gloss value, wherein said second gloss correlation function is associated with a plurality of measured gloss values and mixing ratios of said second high gloss coating component and said matting agent;

(E) producing a target amount of the matting agent based on the first ratio, the second ratio, and a predetermined target amount of the low gloss metallic color coating composition; and

wherein, said binder component, said first and said second binder components are the same or compatible to each other.

The process can further comprise the step of:

(F) mixing said target amount of the matting agent and said predetermined target amount of the low gloss metallic color coating composition to produce said low gloss metallic color coating composition.

The first or the second gloss correlation function can be generated by the aforementioned correlation process.

This disclosure is further directed to a substrate coated with the low gloss metallic coating composition produced with any of the processes disclosed herein.

The substrate can be a signage, equipment, tool, a vehicle, a consumer appliance, a building, or a part thereof.

In one example, a signage having symbols over a background can be produced. The background portion of the signage can be produced with a coating composition having metallic flake pigments and low gloss using the process described herein. The portion for the symbols can be produced with a coating composition having same or different metallic flake pigments and different color. The symbols can be produced with original high gloss coating composition or a low gloss coating composition prepared with the process disclosed herein. With the low gloss appearance background, the color differences between the symbols and the background can be more visible. In another example, an entire substrate can be coated over with a low gloss coating composition prepared according to the process disclosed herein to have a desired low gloss and metallic appearance. In yet another example, a damaged area of a vehicle body coated with an original metallic coating can be repaired with a repair coating composition prepared with the process disclosed herein to match the color and gloss of the original metallic coating.

One advantage of the process disclosed herein is that a target gloss value can be achieved without repeated spray-out test-and-try.

This disclosure is also directed to a coating system for producing a low gloss metallic color coating composition having a target gloss value. The system can comprise:

(1) a high gloss metallic color coating composition comprising a binder component, one or more metallic effect pigments and one or more color pigments dispersed in said binder component;

(2) a matting agent;

(3) a first gloss correlation function associated with a plurality of measured gloss values and mixing ratios of a first high gloss coating component and said matting agent, said first high gloss coating component comprises a first binder component and one or more metallic effect pigments dispersed in said first binder component, but free from said one or more color pigments; and

(4) a second gloss correlation function associated with a plurality of measured gloss values and mixing ratios of a second high gloss coating component and said matting agent, said second high gloss coating component comprises a second binder component and one or more color pigments dispersed in said second binder component, but free from said one or more metallic effect pigment pigments;

wherein a target amount of the matting agent is produced based on said target gloss value, said first and said second gloss correlation functions, and a predetermined target amount of said low gloss metallic color coating composition.

The high gloss metallic coating composition can typically have a gloss value greater than the target gloss value. Commercial colored coating composition packages, such as IMRON® 3.5 HG™, available from E. I. du Pont de Nemours and Company, under the respective trademark or registered trademark, can be suitable.

In another example, the system can comprise:

(1a) a first coating composition comprising a first binder component and one or more metallic effect pigments dispersed in said first binder component and said first coating composition is essentially free from color pigments, and a second coating composition comprising a second binder component and one or more color pigments dispersed in said second binder component and said second coating composition is essentially free from metallic effect pigments;

(2a) a matting agent;

(3a) a first gloss correlation function associated with a plurality of measured gloss values and mixing ratios of a first coating composition and said matting agent; and

(4a) a second gloss correlation function associated with a plurality of measured gloss values and mixing ratios of a second coating composition and said matting agent;

wherein a target amount of the matting agent is produced based on said target gloss value, said first and said second gloss correlation functions, and a predetermined target amount of said low gloss metallic color coating composition.

The first and the second coating compositions typically can have gloss values greater than the target gloss value. Commercial coating compositions, such as metallic Coating Component 701P®, color coating component 9T17® and its other color series, all available from E. I. du Pont de Nemours and Company under respective trademarks or registered trademarks, can be suitable for the first and the second coating compositions, respectively.

This disclosure is further directed to a method for producing a matching coating layer to match flake appearance characteristics, color characteristics, and a target gloss value of a target coating. The method can comprise the steps of:

(a) obtaining the flake appearance characteristics, the color characteristics and the gloss value of the target coating;

(b) retrieving at least one matching formula from a color database based on the flake appearance characteristics and the color characteristics, said matching formula comprises data for one or more binder components, one or more metallic effect pigments and one or more color pigments;

(c) obtaining a first gloss correlation function associated with a plurality of measured gloss values and mixing ratios of a first high gloss coating component and a matting agent, said first high gloss coating component comprising a first binder component and said one or more metallic effect pigments, but free from said one or more color pigments;

(d) obtaining a second gloss correlation function associated with a plurality of measured gloss values and mixing ratios of a second high gloss coating component and said matting agent, said second high gloss coating component comprising a second binder component and said one or more color pigments, but free from said one or more metallic effect pigments;

(e) producing a first ratio of a matting agent and said first high gloss coating component based on the first gloss correlation function and said target gloss value, and a second ratio of the matting agent and the second high gloss coating component based on the second gloss correlation function and said target gloss value; and

(f) producing a target amount of the matting agent based on the first ratio, the second ratio, and a predetermined target amount of a target coating composition; and

wherein, said first and said second binder components can be the same or compatible to each other.

The matching formula can be retrieved according to methods and systems system known in the industry. In one example, the system and methods described in U.S. Pat. No. 7,747,615, can be suitable.

The method can further comprise the step of:

(g) producing the target coating composition based on the matching formula and the target amount of the matting agent.

The method can even further comprise the step of:

(h) applying said target coating composition over a substrate to form the matching coating layer thereon.

The coating compositions produced therein can be applied to the substrate using conventional coating application methods, such as spray, rolling, brush, or any other coating application methods known to those skilled in the art.

The coating compositions produced therein can be applied to the substrate to form a wet coating layer. The wet coating layer can be dried or cured at ambient or elevated temperatures to form a dry coating layer. Typically the coating layer can be cured at a temperature in a range of from 18° C. to 60° C. Typically the coating layer can be cured for a time period, such as in a range of from 30 minutes to 24 hours, or any other time period determined necessary by those skilled in the art.

This disclosure is further directed to a computer program product. The product when installed on a computing device can cause the computing device to perform a computing process comprising the steps of:

(1) receiving a target gloss value;

(2) producing a first ratio of a matting agent and a first high gloss coating component based on a first gloss correlation function and said target gloss value, wherein said first gloss correlation function is associated with a plurality of measured gloss values and mixing ratios of said first high gloss coating component and said matting agent;

(3) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent;

(4) determining fractional amounts of said first and said second high gloss coating components according to a predetermined target amount of a low gloss metallic color coating composition; and

(5) producing a target amount of the matting agent based on the first ratio, the second ratio, and said fractional amounts.

The computer program product can be in stored on a CD, a flash memory drive, a DVD, a floppy disk, a hard drive, a network drive, or a combination thereof.

The computer program product can be produced as a computer readable digital package selected from a downloadable digital file package, a compressed digital file package, a digital package encoded on a computer readable medium, or a combination thereof The computer readable medium can be selected from a compact disk (CD), a DVD, a flash memory device, a hard drive, a serve drive, or a combination thereof

Any of the first or second high gloss coating components, any of the coating compositions, or any of the binder components can be aforementioned 2K or 1K coating compositions and can be of solvent borne or waterborne. Any of the first or second high gloss coating components, any of the coating compositions, or any of the binder components can comprise aforementioned crosslinking component, crosslinkable component, or a combination thereof It is understood that all compositions or components need to be compatible.

### Testing Procedures

Gloss of a coating can be measured by a method described in ASTM D523. Gloss can be measured by a gloss meter (Model AG-4435, BYK-Gardner, Columbia, Md. 21046).

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Procedure 1: Gloss Correlation for Metallic Coating Component

Coating compositions having metallic flake pigments were prepared according to Table 1. The coating compositions were applied to galvanized steel panels, available as Cat No. HDG70G70U from ACT Panels, Hillsdale, Mich., by drawdown blade to a thickness of about 4 mils (about 0.10 mm) and cured for 3 hours at 20° C. Coating gloss was measured according to the Testing Procedures.

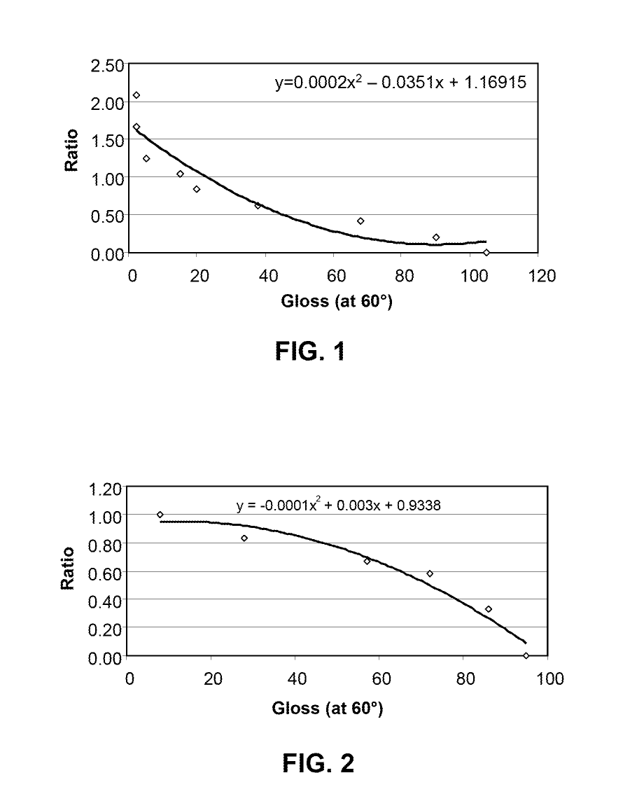

The mixing ratios and gloss values were plotted in FIG. 1. The gloss correlation can be expressed in following formula using multiple regression fitting:

y=0.0002x²−0.0351x+1.6915 (Formula 1)

TABLE 1
Coating Compositions.

| High Gloss | Matting | | | |
|---|---|---|---|---|
| Metallic Coating | Agent² | Mixing | Activator³ | |
| Component¹ (gram) | (gram) | Weight Ratio | (gram) | Gloss at 60° |
| 24 | 0 | 0 | 6 | 105 |
| 24 | 5 | 0.21 | 6 | 90 |
| 24 | 10 | 0.42 | 6 | 68 |
| 24 | 15 | 0.63 | 6 | 38 |
| 24 | 20 | 0.83 | 6 | 20 |
| 24 | 25 | 1.04 | 6 | 15 |
| 24 | 30 | 1.25 | 6 | 5 |
| 24 | 40 | 1.67 | 6 | 2.2 |
| 24 | 50 | 2.08 | 6 | 2.2 |

¹The High Gloss Metallic Coating Component used was 701P ® available from E. I. du Pont de Nemours and Company, under the registered trademark.
²The Matting Agent was 9T20 ® available from E. I. du Pont de Nemours and Company, under the registered trademark.
³The activator was 9T00-A ® available from E. I. du Pont de Nemours and Company, under the registered trademark.

### Procedure 2: Gloss Correlation for Color Coating Component

Coating compositions having solid color pigments were prepared according to Table 2 and Table 3. The coating compositions were applied, cured and measured as described above.

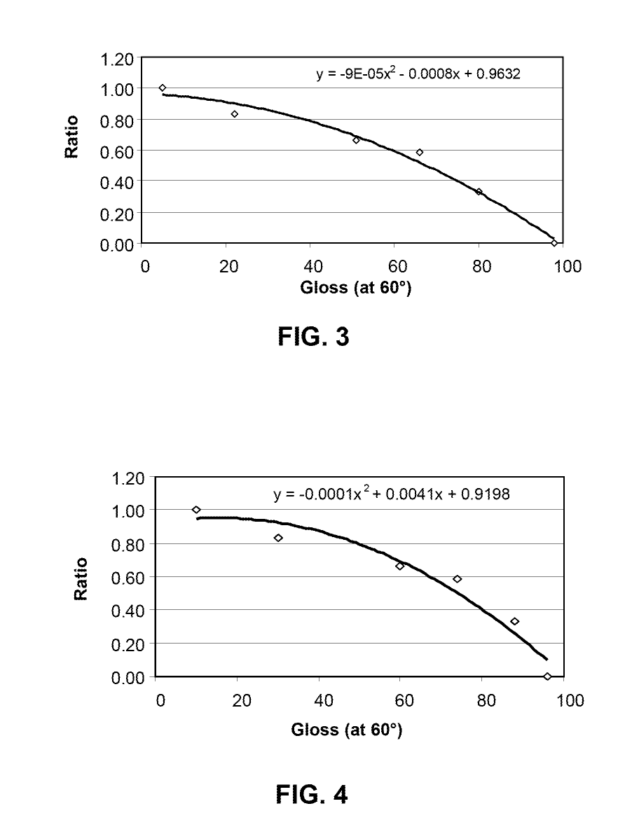

The mixing ratios and gloss values were plotted in FIG. 2 and FIG. 3 for Tables 2 and 3, respectively. The gloss correlations can be expressed in following formulas, respectively:

Blue: y=−0.0001x²+0.003x+0.9338 (Formula 2)

Yellow: y=−9E-05x²−0.0008x+0.9632 (Formula 3)

TABLE 2
Coating Compositions.

| High Gloss Blue | Matting | | | |
|---|---|---|---|---|
| Color Coating | Agent² | Mixing | Activator³ | |
| Component⁴ (gram) | (gram) | Ratio | (gram) | Gloss at 60° |
| 24 | 0 | 0 | 6 | 95 |
| 24 | 8 | 0.33 | 6 | 86 |
| 24 | 14 | 0.58 | 6 | 72 |
| 24 | 16 | 0.67 | 6 | 57 |
| 24 | 20 | 0.83 | 6 | 28 |
| 24 | 24 | 1.00 | 6 | 8 |

²⁻³as described in Table 1.
⁴The High Gloss Blue Color Coating Component used was 9T17 ® available from E. I. du Pont de Nemours and Company, under the registered trademark.

TABLE 3
Coating Compositions.

| High Gloss Yellow | Matting | | | |
|---|---|---|---|---|
| Color Coating | Agent² | Mixing | Activator³ | |
| Component⁵ (gram) | (gram) | Ratio | (gram) | Gloss at 60° |
| 24 | 0 | 0 | 6 | 98 |
| 24 | 8 | 0.33 | 6 | 80 |
| 24 | 14 | 0.58 | 6 | 66 |
| 24 | 16 | 0.67 | 6 | 51 |
| 24 | 20 | 0.83 | 6 | 22 |
| 24 | 24 | 1.00 | 6 | 5 |

²⁻³as described in Table 1.
⁵The High Gloss Yellow Color Coating Component used was 710P ® available from E. I. du Pont de Nemours and Company, under the registered trademark.

### Procedure 3: Gloss Correlation for Binder Component

Coating compositions having no metallic or color pigments were prepared according to Table 4. The coating compositions were applied, cured and measured as described above.

The mixing ratios and gloss values were plotted in FIG. 4. The gloss correlation can be expressed in following formula using multiple regression fitting:

y=−0.0001x²+0.0041x+0.9198 (Formula 4)

TABLE 4
Coating Compositions.

| | Matting | | | |
|---|---|---|---|---|
| Binder Component⁶ | Agent² | Mixing | Activator³ | |
| (gram) | (gram) | Ratio | (gram) | Gloss at 60° |
| 24 | 0 | 0 | 6 | 96 |
| 24 | 8 | 0.33 | 6 | 88 |
| 24 | 14 | 0.58 | 6 | 74 |
| 24 | 16 | 0.67 | 6 | 60 |
| 24 | 20 | 0.83 | 6 | 30 |
| 24 | 24 | 1.00 | 6 | 10 |

²⁻³as described in Table 1.
⁶The binder Component used was 741P ® available from E. I. du Pont de Nemours and Company, under the registered trademark.

### Examples 1-3

Low gloss metallic blue color coating compositions having various gloss values were prepared according to Tables 5 and 6 and as described below.

The low gloss metallic blue color coating compositions were prepared from a metallic high gloss coating component 701P®, a blue color coating component 9T17®, and a matting agent 9T20®, all available from E. I. du Pont de Nemours and Company, under the registered trademarks. Based on target amounts and target gloss values, amounts of the matting agents were calculated according to the gloss correlation formulas, Formula 1 and Formula 2, respectively, for each of the coating components (Table 5).

Based on the target amounts and the Matt agent amount obtained from Table 5, coating compositions were prepared according to Table 6. The coating compositions were applied, cured and measured as described above. Measured gloss values are shown in Table 6.

TABLE 5
Matt Agent Amounts for Low Gloss Metallic Color Coatings.

| | Example 1 | | Example 2 | | Example 3 | |
|---|---|---|---|---|---|---|
| Target Amounts | | | | | | |
| Metallic Coating | 800 | gram | 800 | gram | 800 | gram |
| Component⁷ | | | | | | |
| Blue Color Coating | 200 | gram | 200 | gram | 200 | gram |
| Component⁸ | | | | | | |
| Target Gloss Value | 50 | | 30 | | 10 | |
| (x) | | | | | | |
| Matt Agent⁹ Mixing | | | | | | |
| Ratio (y) for the Tar- | | | | | | |
| get Gloss Value (x): | | | | | | |
| Based on Formula 1 | 0.4365 | | 0.8185 | | 1.3605 | |
| Based on Formula 2 | 0.8338 | | 0.9338 | | 0.9538 | |
| Matt Agent⁹ Amounts | | | | | | |
| based on the ratio and | | | | | | |
| the target amounts: | | | | | | |
| Metallic Coating | 349.20 | gram | 654.80 | gram | 1088.40 | gram |
| Component⁷ | | | | | | |
| Blue Color Coating | 166.76 | gram | 186.76 | gram | 190.76 | gram |
| Component⁸ | | | | | | |
| Total Matt Agent⁹ | 515.96 | gram | 841.56 | gram | 1279.16 | gram |
| Amounts | | | | | | |

⁷The Metallic Coating Component used was 701P ®, available from E. I. du Pont de Nemours and Company, under registered trademark.
⁸The blue color coating component used was 9T17 ®, available from E. I. du Pont de Nemours and Company, under registered trademark.
⁹The matting agent used was 9T20 ®, available from E. I. du Pont de Nemours and Company, under registered trademark.

TABLE 6
Low Gloss Metallic Color Coatings.

| | Example 1 | | Example 2 | | Example 3 | |
|---|---|---|---|---|---|---|
| Target Amounts | | | | | | |
| Metallic Coating | 800 | gram | 800 | gram | 800 | gram |
| Component⁷ | | | | | | |
| Blue Color Coating | 200 | gram | 200 | gram | 200 | gram |
| Component⁸ | | | | | | |
| Matt Agent Amounts | 515.96 | gram | 841.56 | gram | 1279.16 | gram |
| (From Table 5) | | | | | | |
| Activator¹⁰ | 250 | gram | 250 | gram | 250 | gram |

| | | | |
|---|---|---|---|
| Target Gloss Value | 50 | 30 | 10 |
| Measured Gloss Value | 51 | 30 | 9 |

¹⁰The Activator used was 9T00-A ®, available from E. I. du Pont de Nemours and Company, under registered trademark.

### Examples 4-6

Low gloss metallic blue or yellow color coating compositions having various gloss values were prepared according to Tables 7 and 8 and as described below.

The low gloss metallic yellow color coating compositions were prepared from a metallic high gloss coating component 701P®, a yellow color coating component 710P®, a binder component 741P®, and a matting agent 9T20®, all available from E. I. du Pont de Nemours and Company, under the registered trademarks. Based on target amounts and target gloss values, amounts of the matting agents were calculated according to the gloss correlation formulas, Formula 1, Formula 3 and Formula 4, respectively, for each of the coating components (Table 7).

Based on the target amounts and the Matt agent amount obtained from Table 7, coating compositions were prepared according to Table 8. The coating compositions were applied, cured and measured as described above. Measured gloss values are shown in Table 8.

TABLE 7
Matt Agent Amounts for Low Gloss Metallic Color Coatings.

| | Example 4 | | Example 5 | | Example 6 | |
|---|---|---|---|---|---|---|
| Target Amounts | | | | | | |
| Metallic Coating | 800 | gram | 800 | gram | 800 | gram |
| Component⁷ | | | | | | |
| Yellow Color Coating | 50 | gram | 50 | gram | 50 | gram |
| Component¹¹ | | | | | | |
| Binder Component¹² | 150 | gram | 150 | gram | 150 | gram |
| Target Gloss Value | 50 | | 30 | | 10 | |
| (x) | | | | | | |
| Matt Agent⁹ Mixing | | | | | | |
| Ratio (y) for the Tar- | | | | | | |
| get Gloss Value (x): | | | | | | |
| Based on Formula 1 | 0.4365 | | 0.8185 | | 1.3605 | |
| Based on Formula 3 | 0.6982 | | 0.8582 | | 0.9462 | |
| Based on Formula 4 | 0.8748 | | 0.8748 | | 0.9508 | |
| Matt Agent⁹ Amounts | | | | | | |
| based on the ratio and | | | | | | |
| the target amounts: | | | | | | |
| Metallic Coating | 349.20 | gram | 654.80 | gram | 1088.40 | gram |
| Component⁷ | | | | | | |
| Yellow Color Coating | 34.91 | gram | 42.91 | gram | 47.31 | gram |
| Component¹¹ | | | | | | |
| Binder Component¹² | 131.22 | gram | 142.92 | gram | 142.62 | gram |
| Total Matt Agent⁹ | 515.33 | gram | 840.63 | gram | 1278.30 | gram |
| Amounts | | | | | | |

^{7,9 and 10}Same as described above.
¹¹The yellow color coating component used was 710P ®, available from E. I. du Pont de Nemours and Company, under registered trademark.
¹²The Binder Component used was 741P ®, available from E. I. du Pont de Nemours and Company, under registered trademark.

TABLE 8
Low Gloss Metallic Color Coatings.

| | Example 4 | | Example 5 | | Example 6 | |
|---|---|---|---|---|---|---|
| Target Amounts | | | | | | |
| Metallic Coating | 800 | gram | 800 | gram | 800 | gram |
| Component⁷ | | | | | | |
| Yellow Color Coating | 50 | gram | 50 | gram | 50 | gram |
| Component¹¹ | | | | | | |
| Binder Component¹² | 150 | gram | 150 | gram | 150 | gram |
| Matt Agent Amounts | 515.33 | gram | 840.63 | gram | 1278.30 | gram |
| (From Table 7) | | | | | | |
| Activator¹⁰ | 250 | gram | 250 | gram | 250 | gram |

| | | | |
|---|---|---|---|
| Target Gloss Value | 50 | 30 | 10 |
| Measured Gloss Value | 49 | 31 | 9 |

¹⁰The Activator used was 9T00-A ®, available from E. I. du Pont de Nemours and Company, under registered trademark.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A process for producing a low gloss metallic color coating composition having a target gloss value, said process comprising the steps of:
a) producing a first ratio of a matting agent and a first high gloss coating component based on a first gloss correlation function and said target gloss value, wherein said first gloss correlation function is associated with a plurality of measured gloss values and mixing ratios of said first high gloss coating component and said matting agent; and
b) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent.

2. The process of claim 1 further comprising the steps of:
c) determining fractional amounts of said first and said second high gloss coating components according to a predetermined target amount of the low gloss metallic color coating composition;
d) producing a target amount of the matting agent based on the first ratio, the second ratio, and said fractional amounts; and
e) producing said low gloss metallic color coating composition by mixing said target amount of the matting agent and said fractional amounts of said first and said second high gloss coating components.

3. The process of claim 1, wherein said first high gloss coating component comprises a metallic coating composition comprising a first binder component and one or more metallic effect pigments dispersed in said first binder component, said first high gloss coating component is essentially free from color pigments; and wherein said second high gloss coating component comprises at least one color coating composition comprising a second binder component and one or more color pigments dispersed in said second binder component, said second high gloss coating component is essentially free from metallic effect pigments; and wherein said first and said second binder components are the same or compatible to each other.

4. The process of claim 1, wherein said first or said second gloss correlation function is generated by a process comprising the steps of:
i) mixing said matting agent and one of said high gloss coating components at at least two individual mixing ratios to produce individual matt coating compositions;
ii) applying said individual matt coating compositions over individual substrates to form individual matt coating layers;
iii) measuring individual gloss values of said individual matt coating layers; and
iv) generating said first or said second gloss correlation function by plotting or performing a regression according to said individual mixing ratios and said corresponding individual gloss values.

5. The process of claim 1 further comprising the steps of:
f) producing a third ratio of the matting agent and a third high gloss coating component based on a third gloss correlation function and said target gloss value, wherein said third gloss correlation function is associated with a plurality of measured gloss values and mixing ratios of said third high gloss coating component and said matting agent;
g) determining fractional amounts of said first, said second and said third high gloss coating components according to a predetermined target amount of the low gloss metallic color coating composition; and
h) producing a target amount of the matting agent based on the first ratio, the second ratio, the third ration, and said fractional amounts.

6. The process of claim 5 further comprising the steps of:
h1) producing said low gloss metallic color coating composition by mixing said target amount of the matting agent and said fractional amounts of said first, said second and said third high gloss coating components.

7. The process of claim 5, wherein said first high gloss coating component comprises a metallic coating composition comprising a first binder component and one or more metallic effect pigments, said metallic coating composition is essentially free from color pigments;
wherein said second high gloss coating component comprises a color coating composition comprising a second binder component and one or more color pigments, said color coating composition is essentially free from metallic effect pigments; and
wherein said third high gloss coating component comprises a third binder component and is essentially free from both metallic effect pigments and color pigments; and
wherein said first, said second and said third binder components are the same or compatible to each other.

8. The process of claim 5, wherein said first, said second or said third gloss correlation function is generated by a process comprising the steps of:
i) mixing said matting agent and one of said high gloss coating components at at least two individual mixing ratios to produce individual matt coating compositions;
ii) applying said individual matt coating compositions over individual substrates to form individual matt coating layers;
iii) measuring individual gloss values of said individual matt coating layers; and
iv) generating said first or said second gloss correlation function by plotting or performing a regression according to said individual mixing ratios and said corresponding individual gloss values.

9. A process for producing a low gloss metallic color coating composition having a target gloss value from a high gloss metallic color coating composition, said high gloss metallic color coating composition comprising a binder component, one or more metallic effect pigments and one or more color pigments, said process comprising the steps of:
(A) identifying a first high gloss coating component comprising a first binder component and said one or more metallic effect pigments, but free from said one or more color pigments;
(B) identifying a second high gloss coating component comprising a second binder component and said one or more color pigments, but free from said one or more metallic effect pigments;
(C) producing a first ratio of a matting agent and said first high gloss coating component based on a first gloss correlation function and said target gloss value, wherein said first gloss correlation function is associated with a plurality of measured gloss values and mixing ratios of said first high gloss coating component and said matting agent;
(D) producing a second ratio of the matting agent and the second high gloss coating component based on a second gloss correlation function and said target gloss value, wherein said second gloss correlation function is associated with a plurality of measured gloss values and mixing ratios of said second high gloss coating component and said matting agent;
(E) producing a target amount of the matting agent based on the first ratio, the second ratio, and a predetermined target amount of the low gloss metallic color coating composition; and
wherein, said binder component, said first and said second binder components are the same or compatible to each other.

10. The process of claim 9 further comprising the step of:
(F) mixing said target amount of the matting agent and said predetermined target amount of the low gloss metallic color coating composition to produce said low gloss metallic color coating composition.

11. The process of claim 9, wherein said first or said second gloss correlation function is generated by a process comprising the steps of:
i) mixing said matting agent and one of said high gloss coating components at at least two individual mixing ratios to produce individual matt coating compositions;
ii) applying said individual matt coating compositions over individual substrates to form individual matt coating layers;
iii) measuring individual gloss values of said individual matt coating layers; and
iv) generating said first or said second gloss correlation function by plotting or performing a regression according to said individual mixing ratios and said corresponding individual gloss values.

12. A substrate coated with a low gloss metallic coating composition having a target gloss value produced with a process comprising the steps of:
a producing a first ratio of a matting agent and a first high gloss coating component based on a first gloss correlation function and said target gloss value, wherein said first gloss correlation function is associated with a plurality of measured gloss values and mixing ratios of said first high gloss coating component and said matting agent; and
b) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent.

13. The substrate of claim 12, wherein said substrate is a signage, equipment, tool, a vehicle, a consumer appliance, a building, or a part thereof.

14. A coating system for producing a low gloss metallic color coating composition having a target gloss value, said system comprising:
(1) a high gloss metallic color coating composition comprising a binder component, one or more metallic effect pigments and one or more color pigments dispersed in said binder component;
(2) a matting agent;
(3) a first gloss correlation function associated with a plurality of measured gloss values and mixing ratios of a first high gloss coating component and said matting agent, said first high gloss coating component comprises a first binder component and one or more metallic effect pigments dispersed in said first binder component, but free from said one or more color pigments; and
(4) a second gloss correlation function associated with a plurality of measured gloss values and mixing ratios of a second high gloss coating component and said matting agent, said second high gloss coating component comprises a second binder component and one or more color pigments dispersed in said second binder component, but free from said one or more metallic effect pigments;
wherein a target amount of the matting agent is produced based on said target gloss value, said first and said second gloss correlation functions, and a predetermined target amount of said low gloss metallic color coating composition.

15. A coating system for producing a low gloss metallic color coating composition having a target gloss value, said system comprising:
(1a) a first coating composition comprising a first binder component and one or more metallic effect pigments dispersed in said first binder component and said first coating composition is essentially free from color pigments, and a second coating composition comprising a second binder component and one or more color pigments dispersed in said second binder component and said second coating composition is essentially free from metallic effect pigments;
(2a) a matting agent;
(3a) a first gloss correlation function associated with a plurality of measured gloss values and mixing ratios of a first coating composition and said matting agent; and
(4a) a second gloss correlation function associated with a plurality of measured gloss values and mixing ratios of a second coating composition and said matting agent;
wherein a target amount of the matting agent is produced based on said target gloss value, said first and said second gloss correlation functions, and a predetermined target amount of said low gloss metallic color coating composition.

16. A method for producing a matching coating layer to match flake appearance characteristics, color characteristics, and a target gloss value of a target coating, said method comprising the steps of:
(a) obtaining the flake appearance characteristics, the color characteristics and the gloss value of the target coating;
(b) retrieving at least one matching formula from a color database based on the flake appearance characteristics and the color characteristics, said matching formula comprises data for one or more binder components, one or more metallic effect pigments and one or more color pigments;
(c) obtaining a first gloss correlation function associated with a plurality of measured gloss values and mixing ratios of a first high gloss coating component and a matting agent, said first high gloss coating component comprising a first binder component and said one or more metallic effect pigments, but free from said one or more color pigments;
(d) obtaining a second gloss correlation function associated with a plurality of measured gloss values and mixing ratios of a second high gloss coating component and said matting agent, said second high gloss coating component comprising a second binder component and said one or more color pigments, but free from said one or more metallic effect pigments;
(e) producing a first ratio of the matting agent and said first high gloss coating component based on the first gloss correlation function and said target gloss value, and a second ratio of the matting agent and the second high gloss coating component based on the second gloss correlation function and said target gloss value; and
(f) producing a target amount of the matting agent based on the first ratio, the second ratio, and a predetermined target amount of a target coating composition; and
wherein, said first and said second binder components are the same or compatible to each other.

17. The method of claim 16 further comprising the step of:
(g) producing the target coating composition based on the matching formula and the target amount of the matting agent.

18. The method of claim 17 further comprising the step of:
(h) applying said target coating composition over a substrate to form the matching coating layer thereon.

19. A computer program product, said product when installed on a computing device causes said computing device to perform a computing process comprising the steps of:
(1) receiving a target gloss value;
(2) producing a first ratio of a matting agent and a first high gloss coating component based on a first gloss correlation function and said target gloss value, wherein said first gloss correlation function is associated with a plurality of measured gloss values and mixing ratios of said first high gloss coating component and said matting agent;
(3) producing a second ratio of the matting agent and a second high gloss coating component based on a second gloss correlation function and said target gloss value, wherein said second gloss correlation function is associated with a plurality of measured gloss values and mixing ratios of said second high gloss coating component and said matting agent;
(4) determining fractional amounts of said first and said second high gloss coating components according to a predetermined target amount of a low gloss metallic color coating composition; and
(5) producing a target amount of the matting agent based on the first ratio, the second ratio, and said fractional amounts.

20. The computer program product of claim 19, wherein said computer program product is produced as a computer readable digital package selected from a downloadable digital file package, a compressed digital file package, a digital package encoded on a computer readable medium, or a combination thereof.

21. (canceled)
